(19) United States
(12) Patent Application Publication
(10) Pub. No.: US 2024/0213452 A1
(43) Pub. Date: Jun. 27, 2024

(54) ROOM-TEMPERATURE OPERABLE ALL-SOLID-STATE BATTERY

(71) Applicants: HYUNDAI MOTOR COMPANY, Seoul (KR); KIA CORPORATION, Seoul (KR)

(72) Inventors: Seon Hwa Kim, Cheongju-si (KR); Hong Suk Choi, Hwaseong-si (KR); Hee Soo Kang, Seoul (KR); Jae Min Lim, Suwon-si (KR); Sang Wan Kim, Anyang-si (KR)

(73) Assignees: HYUNDAI MOTOR COMPANY, Seoul (KR); KIA CORPORATION, Seoul (KR)

(21) Appl. No.: 18/242,945

(22) Filed: Sep. 6, 2023

(30) Foreign Application Priority Data
Dec. 22, 2022 (KR) 10-2022-0182077

(51) Int. Cl. H01M 4/36; H01M 4/133; H01M 4/134; H01M 4/38; H01M 4/587

(52) U.S. Cl. CPC H01M 4/366; H01M 4/133; H01M 4/134; H01M 4/38; H01M 4/587; H01M 2004/021

(57) ABSTRACT

Disclosed is an all-solid-state battery, which includes a plurality of intermediate layers including a first layer including a carbon material and a second layer including a metal and disposed on at least one surface of the first layer, and in which a lithium precipitation layer in which lithium is electrodeposited is located at the interface of an anode current collector at 40° C. or less, thereby improving volume expansion of the all-solid-state battery and maximizing battery performance.

### CROSS-REFERENCE TO RELATED APPLICATION

This application claims, under 35 U.S.C. § 119(a), the benefit of and priority to Korean Patent Application No. 10-2022-0182077, filed on Dec. 22, 2022, the entire contents of which are incorporated herein by reference.

### BACKGROUND

### (a) Technical Field

The present disclosure relates to a room-temperature operable all-solid-state battery.

### (b) Background Art

An all-solid-state battery includes a cathode composite layer bonded to a cathode current collector, an anode composite layer bonded to an anode current collector, and a solid electrolyte layer interposed between the cathode composite layer and the anode composite layer. The anode composite layer includes an anode active material such as graphite, silicon, etc. and a solid electrolyte. The solid electrolyte conducts lithium ions in the anode composite layer. However, since the solid electrolyte has a greater specific gravity than the liquid electrolyte, the energy density of the all-solid-state battery is lower than that of a lithium ion battery.

A lithium metal battery using lithium metal as the anode of an all-solid-state battery is provided to increase the energy density of an all-solid-state battery. However, lithium metal batteries have many obstacles to be overcome for commercialization, ranging from research technical problems such as interfacial junction, lithium dendrite growth, etc., to industrial technical problems such as price, large-area formation, etc.

Recently, research is ongoing into storage-type anode-free all-solid-state batteries in which the anode is eliminated, and lithium ions are directly precipitated as lithium metal on the anode current collector.

### SUMMARY OF THE DISCLOSURE

An object of the present disclosure is to provide an all-solid-state battery capable of minimizing the effect of volume expansion due to precipitation of lithium metal.

Another object of the present disclosure is to provide an all-solid-state battery in which lithium metal may be precipitated and/or electrodeposited on the interface of an anode current collector at room temperature.

The objects of the present disclosure are not limited to the foregoing. The objects of the present disclosure are understood through the following description and to be realized by the batteries described in the claims and combinations thereof.

The present disclosure provides an all-solid-state battery including an anode current collector, a lithium inducing layer disposed on the anode current collector, a solid electrolyte layer disposed on the lithium inducing layer, a cathode layer disposed on the electrolyte layer, and a cathode current collector disposed on the cathode layer, in which the lithium inducing layer may include a plurality of intermediate layers, and the intermediate layers may include a first layer including a carbon material and a second layer including a metal capable of forming an alloy with lithium and disposed on at least one surface of the first layer.

The all-solid-state battery may further include a lithium precipitation layer disposed between the anode current collector and the lithium inducing layer when charged.

The volume of the first layer may be reduced by a volume that is expanded by the lithium precipitation layer.

The all-solid-state battery may have a volume change of 1% or less between State of Charge (SOC) 100 and SOC 0.

The lithium inducing layer may be interposed between the anode current collector and the solid electrolyte layer so that the second layer faces the solid electrolyte layer, and the first layer faces the anode current collector.

The carbon material may include at least one of carbon nanotubes (CNTs), vapor-grown carbon fibers (VGCFs), carbon nanofibers (CNFs), or any combination thereof.

The carbon material of the first layer may not react electrochemically with lithium ions during charging of the all-solid-state battery.

The metal may include aluminum (AI), zinc (Zn), indium (In), silver (Ag), gold (Au), magnesium (Mg), silicon (Si), bismuth (Bi), germanium (Ge), platinum (Pt), antimony (Sb), or any combination thereof.

The second layer may be deposited on at least one surface of the first layer.

At least a portion of the metal in the second layer may form an alloy with lithium ions when the all-solid-state battery is charged.

The weight per unit area of the metal may be in a range of 0.05 mg/cm² to 0.30 mg/cm².

The intermediate layer may have a ratio (A/B) of a weight (A) of the metal per unit area and a weight (B) of the carbon material per unit area in a range of 0.1 to 1.

The intermediate layer may have a thickness of 6 μm or less.

The lithium inducing layer may have a thickness in a range of 10 μm to 20 μm.

The operation temperature of the all-solid-state battery may be 40° C. or less.

Lithium metal may not be present in the first layer when the all-solid-state battery is charged.

### BRIEF DESCRIPTION OF THE DRAWINGS

The above and other features of the present disclosure are now be described in detail with reference to certain exemplary embodiments thereof illustrated in the accompanying drawings, which are given hereinbelow by way of illustration only, and thus are not limitative of the present disclosure, and wherein:

FIG. 1 shows an example of an all-solid-state battery according to the present disclosure;

FIG. 2 shows the all-solid-state battery according to FIG. 1 that is charged;

FIG. 3 shows an example of a lithium inducing layer according to the present disclosure;

FIG. 4 shows results of observation of the surface of the anode current collector after charging and discharging the all-solid-state battery of Comparative Example 1 several cycles;

FIG. 5 shows results of analysis of a cross section of the all-solid-state battery according to Comparative Example 3 with a scanning electron microscope (SEM);

FIG. 6 shows results of analysis of a cross section of the all-solid-state battery according to Example 1 with an SEM;

FIG. 7 shows charge/discharge curves of the all-solid-state batteries according to Examples 1 to 3 and Comparative Example 5;

FIG. 8 shows results of measurement of capacity retention rates of the all-solid-state batteries according to Examples 1 to 3 and Comparative Example 5;

FIG. 9 shows charge/discharge curves of the all-solid-state batteries according to Examples 1 and 4 and Comparative Example 6; and

FIG. 10 shows results of analysis of a cross section of the all-solid-state battery according to Comparative Example 6 with an SEM.

### DETAILED DESCRIPTION

The above and other objects, features, and advantages of the present disclosure are more clearly understood from the following embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

Throughout the drawings, the same reference numerals refer to the same or like elements. For the sake of clarity of the present disclosure, the dimensions of structures are depicted as being larger than the actual sizes thereof. Although terms such as “first,” “second,” etc. may be used herein to describe various elements, these elements are not to be limited by these terms. These terms are only used to distinguish one element from another element. For instance, a “first” element discussed below may be termed a “second” element without departing from the scope of the present disclosure. Similarly, the “second” element may also be termed a “first” element. As used herein, the singular forms are intended to include the plural forms as well, unless the context clearly indicates otherwise.

The terms “comprise,” “include,” “have,” etc., when used in this specification, specify the presence of stated features, integers, steps, operations, elements, components, or combinations thereof, but do not preclude the presence or addition of one or more other features, integers, steps, operations, elements, components, or combinations thereof. Also, when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

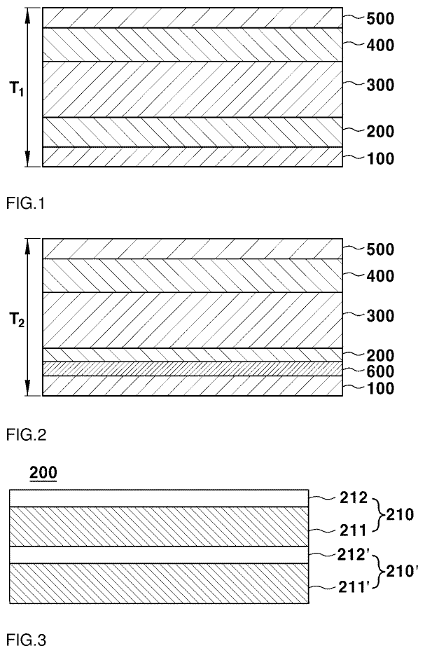

FIG. 1 shows an all-solid-state battery according to an embodiment of the present disclosure. The all-solid-state battery may include an anode current collector 100, a lithium inducing layer 200 disposed on the anode current collector 100, a solid electrolyte layer 300 disposed on the lithium inducing layer 200, a cathode layer 400 disposed on the solid electrolyte layer 300, and a cathode current collector 500 disposed on the cathode layer 400.

The anode current collector 100 may be a plate-shaped substrate having electrical conductivity. Specifically, the anode current collector 100 may be provided in the form of a sheet, thin film, or foil.

The anode current collector 100 may include a material that does not react with lithium. Specifically, the anode current collector 100 may include nickel (Ni), copper (Cu), stainless steel (SUS), or combinations thereof.

The thickness of the anode current collector 100 is not particularly limited, and may be, for example, in a range of 1 μm to 500 μm.

FIG. 2 shows the all-solid-state battery that is charged. The all-solid-state battery that is charged may further include a lithium precipitation layer 600 containing lithium metal and/or a lithium alloy between the anode current collector 100 and the lithium inducing layer 200. At the initial stage of charging of the all-solid-state battery, lithium ions that are released from the cathode layer 400 move to the lithium inducing layer 200 through the solid electrolyte layer 300. The lithium ions react with the metal of the lithium inducing layer 200 to form a lithium alloy between the anode current collector 100 and the lithium inducing layer 200. When charging is continued, lithium is uniformly precipitated around the lithium alloy, thus forming a lithium precipitation layer 600.

An anode-free all-solid-state battery may expand or contract by the volume of the lithium precipitation layer 600 during repeated charging and discharging. Due to the repeated volume change, the contact interface between layers becomes poor, the lithium precipitation layer 600 is formed non-uniformly, and a pressure imbalance occurs in the all-solid-state battery, which adversely affects cell performance and lifespan.

In order to solve the above problems, the present disclosure is characterized that the effect of volume expansion of the all-solid-state battery is reduced by interposing the lithium inducing layer 200 between the anode current collector 100 and the electrolyte layer 300. Specifically, as shown in FIG. 2, the first layers 211, 211′ of the lithium inducing layer 200, (described in greater detail below), are reduced by the expansion volume due to formation of the lithium precipitation layer 600 during charging, and thus T₁ of FIGS. 1 and T₂ of FIG. 2 may be substantially the same as each other. T₁ may be the thickness of the all-solid-state battery in the discharged state. T₂ may be the thickness of the all-solid-state battery in the charged state.

The all-solid-state battery may have a volume change of 1% or less between SOC (state of charge) 100 and SOC 0. Here, SOC 100 may indicate a state in which the all-solid-state battery is fully charged, and SOC 0 may indicate a state in which the all-solid-state battery is fully discharged. In the all-solid-state battery according to the present disclosure, by interposing the lithium inducing layer 200 as described above, there is almost no change in volume before and after charging, so that a problem due to volume expansion of the all-solid-state battery does not occur. The lower limit of the volume change is not particularly limited, and, in certain examples, there is no volume change between SOC 100 and SOC 0.

FIG. 3 shows a lithium inducing layer 200 according to the present disclosure. The lithium inducing layer 200 may include a plurality of intermediate layers 210, 210′. FIG. 3 shows the lithium inducing layer 200 configured such that two intermediate layers 210, 210′ are stacked, but the lithium inducing layer 200 is not limited thereto, and 3, 4, 5, or more intermediate layers 210 may be stacked.

The intermediate layers 210, 210′ may include first layers 211, 211′ including a carbon material, and second layers 212, 212′ disposed on at least one surface of the first layers 211, 211′ and including a metal.

The lithium inducing layer 200 may be interposed between the anode current collector 100 and the solid electrolyte layer 300 such that the second layer 212 faces the solid electrolyte layer 300 and the first layer 211 faces the anode current collector 100.

The carbon material may include carbon nanotubes (CNTs), vapor-grown carbon fibers (VGCFs), carbon nanofibers (CNFs), or combinations thereof. In one particular example, the carbon material includes carbon nanotubes (CNTs).

Conventional anode-free batteries have a problem in that the volume of the battery is increased by the amount of lithium that is precipitated because they use a carbon material in a powder form with high density such as carbon black. However, since the present disclosure includes a porous and elastic carbon material such as carbon nanotubes, when lithium is precipitated, the carbon material becomes thinner and thus volume expansion of the all-solid-state battery may be prevented.

The metal may include aluminum (AI), zinc (Zn), indium (In), silver (Ag), gold (Au), magnesium (Mg), silicon (Si), bismuth (Bi), germanium (Ge), platinum (Pt), antimony (Sb), or combinations thereof. In one particular example, the metal includes silver (Ag).

The second layers 212, 212′ may be deposited on at least one surface of the first layers 211, 211′. Specifically, the second layers 212, 212′ may be deposited on one surface of the first layers 211, 211′ toward the solid electrolyte layer 300.

The second layers 212, 212′ may include a metal capable of alloying with lithium.

Since the all-solid-state battery according to the present disclosure includes a plurality of intermediate layers 210, 210′, it may operate normally even at room temperature of about 40° C. or less. The lower limit of the normal operation temperature of the all-solid-state battery is not particularly limited, and may be, for example, 0° C. or higher, 10° C. or higher, or 20° C. or higher.

The lithium ion conductivity of the lithium alloy formed by reaction between the lithium ions and the metal is greatly deteriorated at room temperature. Hence, when a conventional anode-free battery operates at room temperature, lithium ions do not reach the interface between the lithium inducing layer and the anode current collector and are precipitated and/or electrodeposited in the lithium inducing layer, resulting in defects in the lithium inducing layer. Moreover, when the lithium inducing layer is provided in the form of a thin film so that an anode-free battery operates at room temperature, mechanical properties of the lithium inducing layer may be insufficient, which may cause more defects.

When the all-solid-state battery according to the present disclosure is charged, lithium ions moved to the lithium inducing layer 200 through the solid electrolyte layer 300 are allowed to react with the second layers 212, 212′ contained in the intermediate layers 210, 210′ to form a lithium alloy. Briefly, a plurality of lithium alloys is spaced apart from each other by a predetermined distance in a thickness direction of the lithium inducing layer 200. Therefore, even when the lithium ion conductivity of the lithium alloy is lowered by decreasing the operation temperature of the all-solid-state battery, the lithium alloy may transfer lithium ions to the next lithium alloy step by step, and accordingly, the lithium ions may reach the interface between the lithium inducing layer 200 and the anode current collector 100.

The weight (A) per unit area of the metal may be in a range of 0.05 mg/cm² to 0.30 mg/cm². If the weight thereof exceeds 0.30 mg/cm², battery performance may deteriorate due to increased battery resistance.

The intermediate layer 210 may have a ratio (A/B) of the weight (A) of the metal per unit area and the weight (B) of the carbon material per unit area in a range of 0.1 to 1. If the ratio thereof is less than the above lower limit, lithium ions may be deposited in the carbon material due to excessive carbon material. On the other hand, if the ratio thereof exceeds the above upper limit, cell resistance may increase and thus battery performance may deteriorate.

The thickness of the intermediate layer 210 may be 6 μm or less. The lower limit of the thickness of the intermediate layer 210 is not particularly limited, and may be, for example, 0.01 μm or more, 0.1 μm or more, or 1 μm or more. If the thickness of the intermediate layer 210 exceeds 6 μm, lithium ions may be deposited in the lithium inducing layer 200 without reaching the interface between the lithium inducing layer 200 and the anode current collector 100.

The lithium inducing layer 200 may have a thickness in a range of 10 μm to 20 μm. If the thickness of the lithium inducing layer 200 is less than 10 μm, defects may occur because the first layers 211, 211′ cannot offset the volume expansion. On the other hand, if the thickness of the lithium inducing layer 200 exceeds 20 μm, the energy density of the all-solid-state battery may be lowered, and also lithium ions may be precipitated and/or electrodeposited in the lithium inducing layer 200.

The solid electrolyte layer 300 may be disposed between the cathode layer 400 and the lithium inducing layer 200 and may include a solid electrolyte having lithium ion conductivity.

Examples of the solid electrolyte may include an oxide-based solid electrolyte, a sulfide-based solid electrolyte, or the like. Here, in one example, the solid electrolyte includes a sulfide-based solid electrolyte having high lithium ion conductivity. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one of Ge, Zn, and Ga), Li₂S—GeS₂, Li₂S—SiS₂—Li₃PO₄, Li₂S—SiS₂-LiₓMO_{y} (in which x and y are positive numbers and M is any one of P, Si, Ge, B, Al, Ga, and In), Li₁₀GeP₂S₁₂, or the like.

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), or the like.

The cathode layer 40 may include a cathode active material, a solid electrolyte, a conductive material, a binder, or the like.

The cathode active material may include an oxide-based active material.

Examples of the oxide-based active material may include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one of Al, Mg, Co, Fe, Ni and Zn, 0<x+y<2), lithium titanate such as Li₄Ti₅O₁₂, or the like.

The solid electrolyte may include an oxide-based solid electrolyte or a sulfide-based solid electrolyte. In one example, the solid electrolyte is a sulfide-based solid electrolyte having high lithium ion conductivity. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one of Ge, Zn, and Ga), Li₂S—GeS₂, Li₂S—SiS₂—Li₃PO₄, Li₂S—SiS₂-LiₓMO_{y} (in which x and y are positive numbers and M is any one of P, Si, Ge, B, Al, Ga, and In), Li₁₀GeP₂S₁₂, or the like.

Examples of the conductive material may include carbon black, conductive graphite, ethylene black, graphene, or the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like.

The cathode current collector 500 may include a plate-shaped substrate having electrical conductivity. The cathode current collector 500 may include an aluminum foil.

A better understanding of the present disclosure may be obtained through the following examples and comparative examples. However, these examples are not to be construed as limiting the scope of the present disclosure.

### Preparation Example: Manufacture of all-Solid-State Battery

A lithium inducing layer was formed by stacking an intermediate layer on an anode current collector. A carbon nanotube sheet on which silver (Ag) was deposited was used as the intermediate layer.

A solid electrolyte layer including a sulfide-based solid electrolyte and a binder was prepared.

A cathode layer was formed by applying a slurry including a cathode active material, a sulfide-based solid electrolyte, a binder, and a conductive material onto an aluminum foil as a cathode current collector and drying the slurry.

An all-solid-state battery was manufactured by stacking each layer structure so that the lithium inducing layer and the cathode layer were in contact with respective surfaces of the solid electrolyte layer.

### Test Example 1: Comparison of all-Solid-State Battery Performance Depending on Thickness of Lithium Inducing Layer

A test was performed to compare the performance of the all-solid-state batteries of Comparative Examples 1 to 3 in which the intermediate layer and the lithium inducing layer were manufactured in configurations shown in Table 1 below. Each all-solid-state battery was charged and discharged at 40° C. or less, and location of the lithium precipitation layer and occurrence of defects were measured and evaluated. The results thereof are shown in Table 1 below.

TABLE 1

| | | Comparative | Comparative | Comparative | |
|---|---|---|---|---|---|
| Classification | Items | Example 1 | Example 2 | Example 3 | Example 1 |
| Intermediate | (A) Weight of metal | 0.14 | 0.15 | 0.15 | 0.16 |
| layer | per unit area | | | | |
| | (mg/cm²) | | | | |
| | (B) Weight of | 0.24 | 0.43 | 0.70 | 0.47 |
| | carbon material per | | | | |
| | unit area (mg/cm²) | | | | |
| | A/B | 0.58 | 0.35 | 0.21 | 0.34 |
| | Thickness of | 3 | 6 | 10 | 6 |
| | intermediate layer | | | | |
| | (μm) | | | | |
| Lithium | Number of stacked | 1 | 1 | 1 | 2 |
| inducing layer | intermediate layers (n) | | | | |
| | Thickness of lithium | 3 | 6 | 10 | 12 |
| | inducing layer (μm) | | | | |
| Result analysis | Location of | Interface between | | Inside lithium | Interface between |
| | electrodeposition of | lithium inducing | | inducing layer | lithium inducing |
| | lithium ions | layer and anode | | (first layer) | layer and anode |
| | | current collector | | | current collector |
| | Occurrence of | Occurrence | | No | No |
| | defects | | | occurrence | occurrence |
| | Good/poor | Poor | | | Good |
| | judgment | | | | |

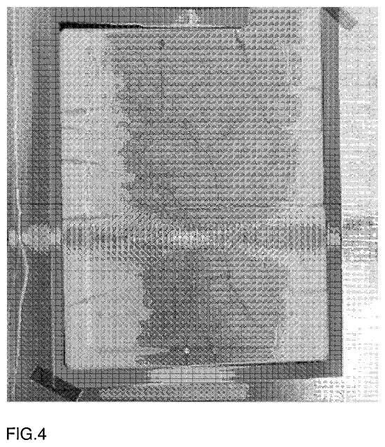

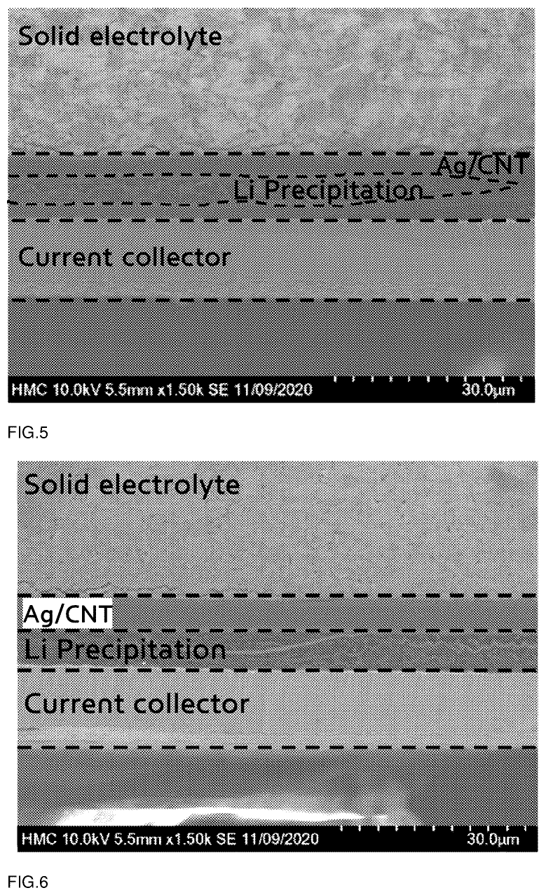

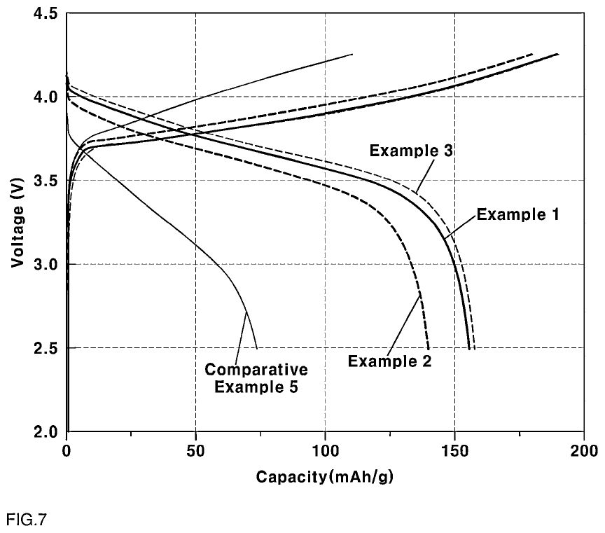

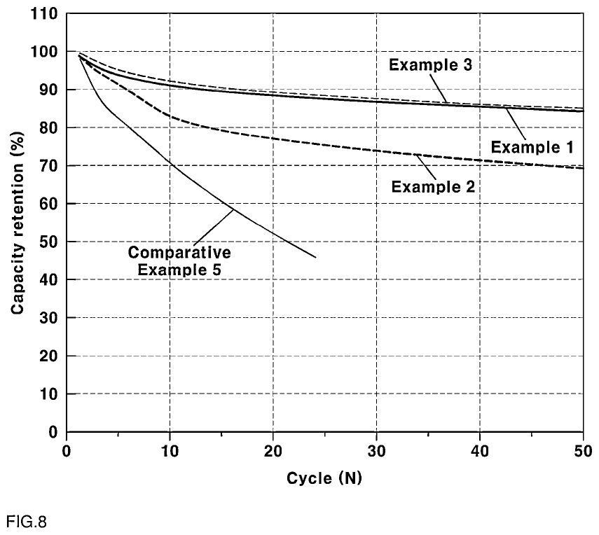

FIG. 4 shows results of observation of the surface of the anode current collector after charging and discharging the all-solid-state battery of Comparative Example 1 several cycles. FIG. 5 shows results of analysis of a cross section of the all-solid-state battery according to Comparative Example 3 with an SEM. FIG. 6 shows results of analysis of a cross section of the all-solid-state battery according to Example 1 with an SEM.

All of Comparative Examples 1 to 3 had the same number of stacked intermediate layers.

In Comparative Examples 1 and 2, the lithium precipitation layer was located at the interface between the lithium inducing layer and the anode current collector, but defects occurred because the thickness of the lithium inducing layer was less than 10 μm.

In Comparative Example 3, since the thickness of the intermediate layer exceeded 6 μm, lithium ions were electrodeposited inside the lithium inducing layer as shown in FIG. 5.

Even when the number of stacked layers is the same, in the case in which the thickness of the intermediate layer and the thickness of the lithium inducing layer are different and fall out of the ranges of the present disclosure, it can be confirmed that the performance deteriorates.

In contrast, in Example 1, since the lithium precipitation layer was located at the interface between the lithium inducing layer and the anode current collector, there was no problem in battery performance.

### Test Example 2: Comparison of all-Solid-State Battery Performance Depending on Weight of Metal Per Unit Area

A test was conducted to compare the performance of the all-solid-state batteries of Examples 1 to 3 and Comparative Example 5 in which the intermediate layer and the lithium inducing layer were manufactured in configurations shown in Table 2 below. Each all-solid-state battery was charged and discharged at 40° C. or less, and location of the lithium precipitation layer and occurrence of defects were measured and evaluated. The results thereof are shown in Table 2 below.

TABLE 2

| | | | | | Comparative |
|---|---|---|---|---|---|
| Classification | Items | Example 1 | Example 2 | Example 3 | Example 5 |
| Intermediate | (A) Weight of metal per | 0.16 | 0.07 | 0.28 | 0.53 |
| layer | unit area (mg/cm²) | | | | |
| | (B) Weight of carbon | 0.47 | 0.46 | 0.46 | 0.46 |
| | material per unit area | | | | |
| | (mg/cm²) | | | | |
| | A/B | 0.34 | 0.15 | 0.61 | 1.15 |
| | Thickness of intermediate | 6 | 6 | 6 | 6 |
| | layer (μm) | | | | |
| Lithium | Number of stacked | 2 | 2 | 2 | 2 |
| inducing layer | intermediate layers (n) | | | | |
| | Thickness of lithium | 12 | 12 | 12 | 12 |
| | inducing layer (μm) | | | | |
| Result analysis | Good/poor judgment | Good | Good | Good | Poor |

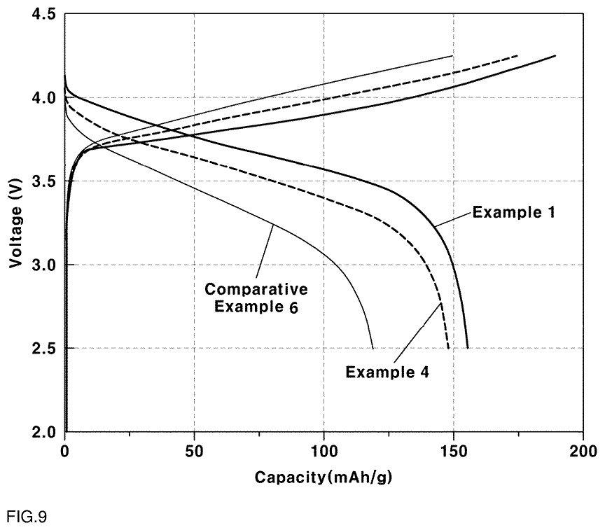

FIG. 7 shows charge/discharge curves of the all-solid-state batteries according to Examples 1 to 3 and Comparative Example 5. FIG. 8 shows results of measurement of capacity retention rates of the all-solid-state batteries according to Examples 1 to 3 and Comparative Example 5.

Comparative Example 5 in which the weight (A) of metal per unit area exceeded 0.3 mg/cm² exhibited low capacity and unstable charging and discharging.

### Test Example 3: Comparison of all-Solid-State Battery Performance Depending on Thickness of Lithium Inducing Layer

A test was conducted to compare the performance of the all-solid-state batteries of Examples 1 and 4 and Comparative Example 6 in which the intermediate layer and the lithium inducing layer were manufactured in configurations shown in Table 3 below. Each all-solid-state battery was charged and discharged at 40° C. or less, and location of the lithium precipitation layer and occurrence of defects were measured and evaluated. The results thereof are shown in Table 3 below.

TABLE 3

| | | | | Comparative |
|---|---|---|---|---|
| Classification | Items | Example 1 | Example 4 | Example 6 |
| Intermediate | (A) Weight of metal per | 0.16 | 0.16 | 0.16 |
| layer | unit area (mg/cm²) | | | |
| | (B) Weight of carbon | 0.47 | 0.47 | 0.47 |
| | material per unit area | | | |
| | (mg/cm²) | | | |
| | A/B | 0.34 | 0.34 | 0.34 |
| | Thickness of intermediate | 6 | 6 | 6 |
| | layer (μm) | | | |
| Lithium | Number of stacked | 2 | 3 | 4 |
| inducing layer | intermediate layers (n) | | | |
| | Thickness of lithium | 12 | 18 | 24 |
| | inducing layer (μm) | | | |
| Result analysis | Performance of all-solid- | Good | | |
| | state battery | | | |

| | | |
|---|---|---|
| Location of | Interface between lithium | Inside lithium |
| electrodeposition | inducing layer and anode | inducing layer |
| of lithium ions | current collector | (first layer) |
| Good/poor judgment | Good | Poor |

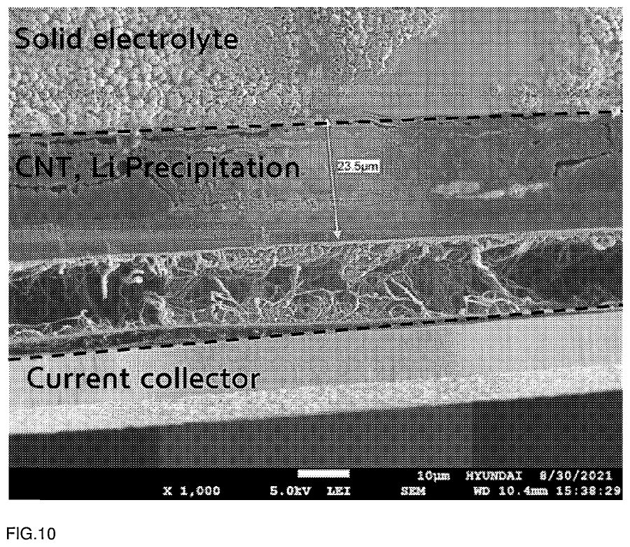

FIG. 9 shows charge/discharge curves of the all-solid-state batteries according to Examples 1 and 4 and Comparative Example 6. FIG. 10 shows results of analysis of a cross-section of the all-solid-state battery according to Comparative Example 6 with an SEM.

In Comparative Example 6 in which the thickness of the lithium inducing layer exceeded 20 μm, a problem in that the lithium precipitation layer was located inside the lithium inducing layer occurred.

As is apparent from the above description, according to the present disclosure, it is possible to obtain an all-solid-state battery with minimized volume change during charging and discharging.

According to the present disclosure, an all-solid-state battery in which lithium metal can be precipitated and/or electrodeposited on the interface of an anode current collector can be obtained.

According to the present disclosure, it is possible to obtain an all-solid-state battery with increased cell performance and lifespan.

The effects of the present disclosure are not limited to the above-mentioned effects. It should be understood that the effects of the present disclosure include all effects that can be inferred from the description of the present disclosure.

Although specific embodiments of the present disclosure have been described, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. An all-solid-state battery comprising:
an anode current collector;
a lithium inducing layer disposed on the anode current collector;
a solid electrolyte layer disposed on the lithium inducing layer such that the lithium inducing layer is disposed between the anode current collector and the solid electrolyte layer;
a cathode layer disposed on the solid electrolyte layer such that the solid electrolyte layer is disposed between the lithium inducing layer and the cathode layer; and
a cathode current collector disposed on the cathode layer such that the cathode layer is disposed between the solid electrolyte layer and the cathode current collector,
wherein the lithium inducing layer comprises a plurality of intermediate layers,
wherein the plurality of intermediate layers comprises a first layer comprising a carbon material and a second layer comprising a metal capable of alloying with lithium, and
wherein the second layer is disposed on at least one surface of the first layer.

2. The all-solid-state battery of claim 1, further comprising:
a lithium precipitation layer disposed between the anode current collector and the lithium inducing layer when charged.

3. The all-solid-state battery of claim 2, wherein a volume of the first layer is reduced by a volume that is expanded by the lithium precipitation layer.

4. The all-solid-state battery of claim 1, wherein the all-solid-state battery has a volume change of 1% or less between State of Charge (SOC) 100 and SOC 0.

5. The all-solid-state battery of claim 1, wherein the lithium inducing layer is disposed between the anode current collector and the solid electrolyte layer so that the second layer of the plurality of intermediate layers faces the solid electrolyte layer and the first layer of the plurality of intermediate layers faces the anode current collector.

6. The all-solid-state battery of claim 1, wherein the carbon material of the first layer of the plurality of intermediate layers comprises carbon nanotubes, vapor-grown carbon fibers, carbon nanofibers, or any combination thereof.

7. The all-solid-state battery of claim 1, wherein the carbon material of the first layer of the plurality of intermediate layers does not react electrochemically with lithium ions during charging.

8. The all-solid-state battery of claim 1, wherein the metal of the second layer of the plurality of intermediate layers comprises aluminum, zinc, indium, silver, gold, magnesium, silicon, bismuth, germanium, platinum, antimony, or any combination thereof.

9. The all-solid-state battery of claim 1, wherein the second layer of the plurality of intermediate layers is deposited on the first layer of the plurality of intermediate layers.

10. The all-solid-state battery of claim 1, wherein at least a portion of the metal in the second layer of the plurality of intermediate layers is configured to form an alloy with lithium ions when the all-solid-state battery is charged.

11. The all-solid-state battery of claim 1, wherein a weight per unit area of the metal of the second layer of the plurality of intermediate layers is in a range of 0.05 mg/cm² to 0.30 mg/cm².

12. The all-solid-state battery of claim 1, wherein the plurality of intermediate layers has a ratio (A/B) of a weight (A) of the metal of the second layer of the plurality of intermediate layers per unit area and a weight (B) of the carbon material of the first layer of the plurality of intermediate layers per unit area in a range of 0.1 to 1.

13. The all-solid-state battery of claim 1, wherein the plurality of intermediate layers has a thickness of 6 μm or less.

14. The all-solid-state battery of claim 1, wherein the lithium inducing layer has a thickness in a range of 10 μm to 20 μm.

15. The all-solid-state battery of claim 1, wherein an operation temperature of the all-solid-state battery is 40° C. or less.

16. The all-solid-state battery of claim 1, wherein lithium metal is not present in the first layer when the all-solid-state battery is charged.
